(19) United States
(12) Patent Application Publication
(10) Pub. No.: US 2008/0178376 A1
(43) Pub. Date: Jul. 31, 2008

(54) Sealing device for vacuum urinals in aircraft

(75) Inventors: Christian Seibt, Buchholz (DE); Hans-Georg Schuldzig, Jork (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Airbus Deutschland GmbH, Hamburg (DE)

(21) Appl. No.: 12/011,014

(22) Filed: Jan. 23, 2008

Related U.S. Application Data
(60) Provisional application No. 60/898,648, filed on Jan. 31, 2007.

(30) Foreign Application Priority Data
Jan. 31, 2007 (DE) 10 2007 004 833.7

(51) Int. Cl. B64D 11/02; E03F 1/00; E03D 13/00; F16J 15/02

(52) U.S. Cl. 4/301; 277/312; 277/628

(57) ABSTRACT

A sealing device for vacuum urinals in aircraft, with a container having an upper and lower opening cross section, and with a spherical closure in the form of a sphere. The diameter of the spherical closure is greater than the diameter of the lower opening cross section, and the spherical closure can be accommodated by the container. The spherical closure can further be moved from a sealed setting to an open setting, and from the open setting to the sealed setting, wherein the lower opening cross section is sealed by the spherical closure in the sealed setting.

### CROSS-REFERENCE TO RELATED APPLICATIONS

This application claims the benefit of the filing date of U.S. Provisional Patent Application No. 60/898,648 filed Jan. 31, 2007, the disclosure of which is hereby incorporated herein by reference.

### FIELD OF THE INVENTION

The invention relates to a sealing device for vacuum urinals, in particular vacuum urinals on board of aircrafts, in particular air plains, as well as to a method for actuating such a sealing device, a vacuum urinal equipped with at least one respective sealing device, and an airplane containing said sealing device.

### BACKGROUND OF THE INVENTION

In particular on board airplanes, the sanitary areas are located in direct proximity to the nearest rows of passenger seats. The toilets and urinals situated in the sanitary area are here often located a distance of less than one meter from the nearest passenger seat. The close proximity of the mentioned facilities poses a potential nuisance to passengers owing to the background noise and odors emanating from the sanitary area, in particular the toilets and urinals. This affects the passengers seated closest to the sanitary are in particular. The background noise stems in particular for the flushing of toilets and urinals.

In order to counter the noise emission, DE 42 01 986 C1 describes a device for flushing a vacuum toilet. The device is suitable in particular for use in the area of aviation. A trigger, rinsing water valve and suction valve are provided, wherein the suction valve is situated in the area of a connecting line extending between a toilet bowl and storage tank. The suction valve is arranged at the end of the connecting line facing the toilet bowl. Provided in the area of the suction valve port facing the storage tank is a coupling, which links the connecting line to a bypass valve.

Hence, DE 42 01 986 C1 discloses a device that is suitable for reducing noises and undesired odors.

### SUMMARY OF THE INVENTION

One object of the invention is to propose a sealing device for vacuum urinals in aircraft, which may effectively diminishes noises in particular during the flushing process in toilets or urinals, and further cuts down on odor production. Another object of the invention is to propose a sealing device for vacuum urinals in aircraft that is especially easy to design and retrofit, and inexpensive to manufacture.

The object may be achieved with a sealing device for vacuum urinals in aircraft according to claim 1. The sealing device exhibits a container with an upper opening cross section and a lower opening cross section, and a spherical closure in the form of a sphere. The diameter of the spherical closure is greater than the diameter of the lower opening cross section, and the spherical closure can be accommodated in the container, and shifted from a sealed to open setting, and an open to sealed setting. In the sealed setting, the lower opening cross section is sealed by the spherical closure. Further developments of the invention are specified in the subclaims.

The indicated sealing device can basically be realized only with two components, namely the container and the spherical closure in the form of a sphere. The container design preferably consists of at least two parts, wherein the parts can preferably be bolted or bonded together, or mounted by means of a screw or several screws. The spherical closure can be a commercially available table tennis ball, for example. Any ball weighing as little as possible, such as a hollow ball or a ball made out of especially light material, is basically suitable for realizing the spherical closure. However, in order to satisfy the hygiene requirements for sanitary areas, the spherical closure and container should have as smooth a surface as possible. To this end, the container and/or spherical closure can be covered with a suitable anti-adhesive surface material to counter the tendency toward dirt accumulation.

In a further development of the invention, it may be preferred that the container and/or spherical closure exhibit an anti-adhesive surface to counter the deposit of urinary calculus or other contaminants.

In another further development of the invention, the sealing device may also exhibit a guiding means, through which the spherical closure is movably guided. The guiding means can be a brace situated in the container, which can further be joined to the container as a single piece. In the aforementioned embodiment, the spherical closure is guided on the one hand through the container, in particular its lateral walls, and on the other through the mentioned brace. As a result of the guide, contaminants can be mechanically removed from the spherical closure while moving up and down as the result of friction on the guiding means. Instead of a single guiding means, the spherical closure can also be guided by several guiding means, in particular three guiding rods. Guiding the spherical closure via three guiding rods produces a spatial independence from the lateral walls of the container, so that the spherical closure can be situated in roughly the middle of the container.

In another further development of the invention, the upper opening cross section of the sealing device is circular, and situated at a lateral distance from an uppermost point of the spherical closure. This distance may be measure with at least 2 mm in length. As a result of this arrangement of the opening cross section relative to the spherical closure, the spherical closure executes a rotating motion as liquid is introduced through the upper opening cross section. Otherwise, it is especially advantageous for the opening cross section to be formed by an inlet nozzle that can specifically steer the liquid jet. In other words, the liquid jet tangent to the spherical closure and striking it from above causes the spherical closure to rotate, and the spherical closure from being pressed onto the lower opening cross section when hit by liquid and transported material, thereby preventing the liquid from discharging. The rotating motion of the spherical closure also prevents contaminants from dotting the spherical closure, wherein in particular coarser contaminants are kept away from the spherical surface through friction on suitable contact surfaces of the container, e.g., the seals at the lower opening cross section.

In a further development of the invention, a vacuum urinal can be equipped with two sealing devices. The first sealing device is preferably situated on a discharge device of the vacuum urinal, while the second sealing device is located on an overflow device of the vacuum urinal. The liquid discharged from the discharge device and overflow device fills the container of the sealing device until the weight exerted by the liquid volume expelled from the spherical closure is identical to the weight of the spherical closure. As a consequence, the spherical closure is lifted by buoyancy, and releases the lower opening cross section of the container in the open setting. After the lower opening cross section has been released, the fluids and transported material can be discharged and, for example, collected in front of a closed suction valve, wherein the suction valve opens after a preset time or after actuating the sensor, and the mentioned fluids and transported material are evacuated under a vacuum. As the fluids and transported material are discharged from the container, the spherical closure again drops toward the lower opening cross section, where it finally forms an effective odor seal and seals off the discharge line against rising odors.

The lower opening cross section can advantageously be equipped with a packing ring, thereby making it possible to achieve an even better seal against rising odors. The mentioned discharge device preferably exhibits a discharge, a discharge line, a bypass line and a sound damper. The sound damper is used in particular to reduce noises, more precisely to reduce noises produced by the evacuation of liquid and transported material.

Further, the invention can be further developed via the waterless operation of a urinal equipped with the sealing device according to the invention. The waterless operation of vacuum urinals is especially advantageous because it saves on weight for air travel. In particular, no rinsing water supply unit and no water supply for operating the vacuum urinals must be included in the aircraft. With respect to aviation, this is associated with a reduction in fuel consumption.

Further, a further development of the invention proposes a method for actuating a sealing device according to the main claim. The spherical closure is here moved from the sealed to open setting by imparting buoyancy to the spherical closure by introducing liquid, releasing the lower opening cross section. As the spherical closure is moved from the open to sealed setting, it closes off the lower opening cross section of the container after the liquid has been discharged under just its own weight. Buoyancy is known to work against gravitational force. Buoyancy is always created when an object, in this case the spherical closure, is located in a fluid, or a liquid, and displaces it. This effect is commonly described as the Archimedes principle, and is utilized in the sealing device, in particular for the spherical closure. In addition, the method can be developed further by facilitating the process of moving the spherical closure from the open to sealed setting by generating a vacuum in the area of the lower opening cross section. In particular, the mentioned further development makes it possible to effectively shorten the necessary discharge time for the liquid.

In a further development, the invention can also be designed to introduce the liquid through one of the mentioned opening cross sections and into the container of the sealing device in such a way that a tangent applied to the direction of liquid flow intersects the spherical closure spaced apart from the midpoint of the spherical closure. The distance selected preferably exceeds 2 mm. This imparts rotation to the spherical closure, making it possible to attain the advantages cited above. Further, the invention can be further developed by an airplane equipped with at least one of the sealing devices according to the invention.

These and other aspects will be made evident through reference to the drawings described below.

### BRIEF DESCRIPTION OF THE DRAWINGS

Exemplary embodiments of the invention will be described in greater detail below with reference to the following drawings.

FIG. 1 shows a system for flushing a vacuum urinal equipped with a sealing device according to the invention.

FIG. 2 shows the sealing device with a spherical closure in the sealed setting.

FIG. 3 shows the sealing device according to FIG. 2 with the spherical closure in the open setting.

FIG. 4 shows a discharge and overflow device for a vacuum urinal, equipped with the sealing device according to FIGS. 2 and 3.

### DETAILED DESCRIPTION

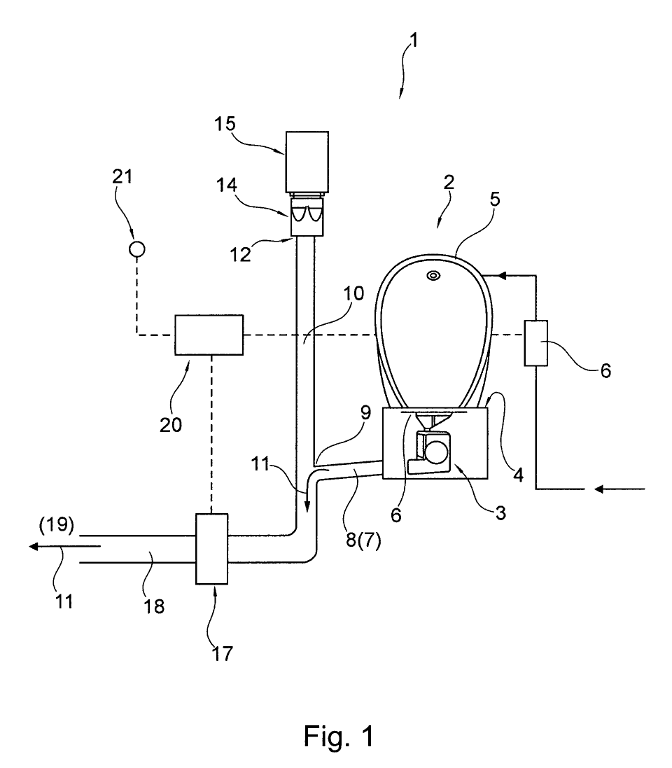

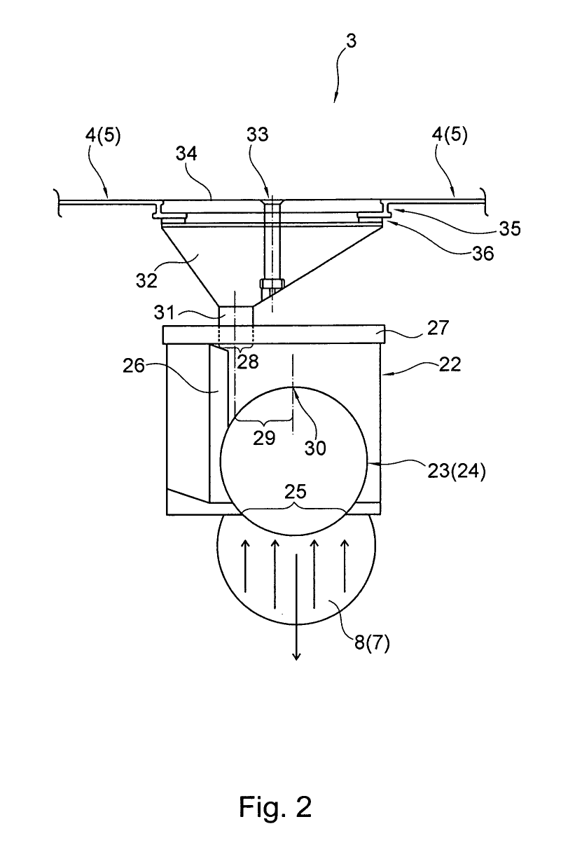

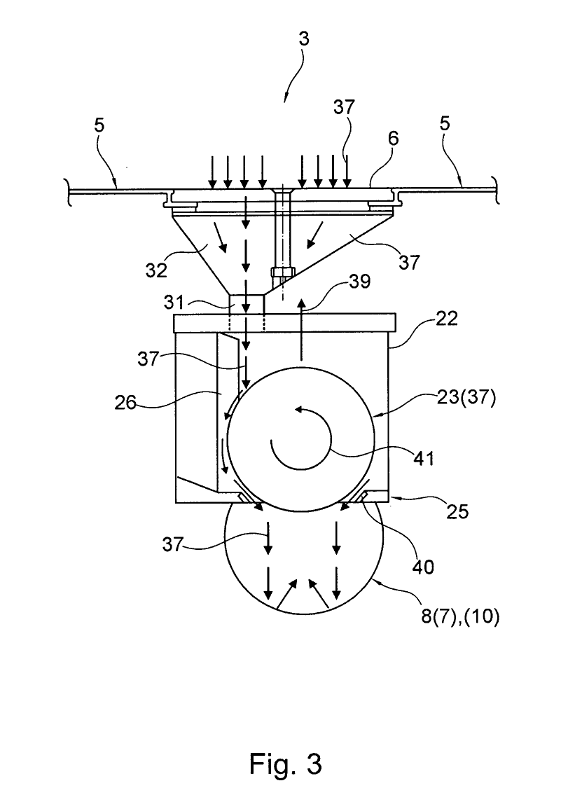

The exemplary embodiment of a system 1 for flushing a vacuum urinal 2 shown on FIG. 1 exhibits a sealing device 3, which is described in even greater detail on FIGS. 2 and 3. The sealing device 3 is situated in the lower area 4 of a urinal bowl 5. To this end, the vacuum urinal 2, more specifically the urinal bowl 5, contains a discharge 6, which is hooked up to a discharge device 7 that exhibits a discharge line 8. The sealing device 3 arranged on the discharge 6 of the urinal bowl 5 is provided in particular for preventing odor formation and flowing noises.

The discharge line 8 empties via a coupling 9 into a bypass line 10. As shown on FIG. 1, the discharge line 8 has a predetermined inclination so as to convey any transported material located therein and the rinsing water in the direction of the bypass line 10 along directional arrow 11 under gravitational force. An upper end 12 of the bypass line 10 facing the environment contains a valve seal 14 in the form of a check valve along with an aspirating sound damper 15 for additionally reducing noise emissions. The valve seal 14 and aspirating sound damper 15 are located above the coupling 9, as shown.

According to the depicted exemplary embodiment, the aspirating sound damper 15 and valve seal 14 are arranged in such a way that an air inlet opening of the aspirating sound damper 15 and the valve seal 14 lie above a maximum possible liquid level.

Further, the other end 16 of the bypass line 10 empties into a suction valve 17 below the coupling 9. The suction valve 17 is hooked up to a wastewater line 18. The wastewater line 18 is in turn connected to a vacuum system 19, which generates a vacuum, and thereby an eddy current in the wastewater line 18. The suction valve 17 can be opened and closed, and when open allows the so-called eddy current to arise in the bypass line 10 and discharge line 8.

As shown by the dashed lines on FIG. 1, the valves are actuated by a control unit 20. The control unit 20 is connected with a trigger device 21, which in the exemplary embodiment is a control button, which can be actuated by a user of the vacuum urinal 2 to initiate the flushing process after actuation. As an alternative, the flushing process can be automatically initiated with a corresponding sensor. Flushing can be initiated through sensor detection before use, after use or upon closing the urinal lid.

FIG. 2 shows the sealing device 3 as mounted to the lower area 4 of the urinal bowl 5. A lower area 4 of the urinal bowl 5 is here only partially shown. In addition to the container 22, the sealing device 3 exhibits in particular a spherical closure 23 in the form of a commercially available table tennis ball. The spherical closure 23 is shown in a sealed setting 24, in which a lower opening cross section 25 of the container 22 is sealed. As depicted, the interior space of the container 22 extends over the lower opening cross section, and the discharge line 8 of the discharge device 7 is shown under the lower opening cross section 25. Also shown is a guiding means 26 in the form of a guiding brace, which guides the spherical closure 23 in a possible up and down motion, and scrapes off potential exterior contaminants of the spherical closure 23 as the spherical closure 23 rotates. The container 22 is limited from above by a cover device 27, which forms an upper opening cross section 28 of the container 22. The upper opening cross section 28 is circular in design, just as the lower opening cross section 25. Further, the upper opening cross section is arranged at a lateral distance 29 to an uppermost point 30 of the spherical closure 23. The description to FIG. 3 specifies reasons for this preferred arrangement. An inlet nozzle 31 is connected with the upper opening cross section 28 from above, enabling a targeted introduction of liquid into the container 22. The inlet nozzle 31 is in turn connected with an inlet funnel 32, which is joined with the urinal bowl 5 via attachment means 33 and a screen 34.

Located between the inlet funnel 32 and the urinal bowl 5, in particular its lower connecting flange 35, is a packing ring 36, which seals the mentioned units away from the environment.

FIG. 3 shows the sealing device 3 with the spherical closure 23 in the open setting 37. The open setting 37 is achieved by initiating a flushing process. The fluids discharged from the discharge 6 of the urinal bowl 5 in the flowing direction marked by arrows 37 here fill the interior of the container 22 until the weight of the fluids displaced from the spherical closure 23 is identical to the weight of the spherical closure 23. As a result, the spherical closure 23 is lifted by buoyancy in arrow direction 39, and opens access via the lower opening cross section 25 to the discharge line 8 of the discharge device 7, which is depicted perpendicular to the image plane on FIG. 3. The fluids and potentially the transported material can hence be discharged in the discharge line 8 toward the bypass line 10, and are accumulated in front of a sealed suction valve (not shown here). After the container 22 of the sealing device 3 has been drained, the spherical closure 23 again drops back into the sealed setting 24 depicted on FIG. 2. The discharge line 8 is hence tightly sealed against rising odors, preferably with an additional packing ring 40.

In a flushing process, the primary air stream is routed through the bypass line 10, which is coupled via the suction valve (not shown here) to the vacuum system (also not shown here). The spherical closure 23 of the sealing device 3 is pulled toward the seal 39 during the flushing process by the generated vacuum, and forms a tight seal. No air is aspirated at the discharge 6 of the urinal bowl 5 during the flushing process. Readily visible is the rotation in the direction of arrow 41 caused by the flowing direction of the fluid. In particular, the rotation of the spherical closure 23 makes it possible to strip contaminants of the spherical closure 23 from the guiding means 26. In particular, the inlet nozzle 31 is situated in such a way that the spherical closure 23 is made to rotate as mentioned. The tangent jet of incoming liquid stimulates the rotation of the spherical closure 23, and when hitting the spherical closure 23, prevents it from being pressed against the gasket ring 30, thereby not allowing the liquid to discharge. In particular, the rotating motion of the spherical closure 23 prevents it from becoming spotted with dirt, since the spherical surface of the spherical closure 23 is kept free of coarser contaminants via abrasion on the guiding means 26 and on the gasket ring 40.

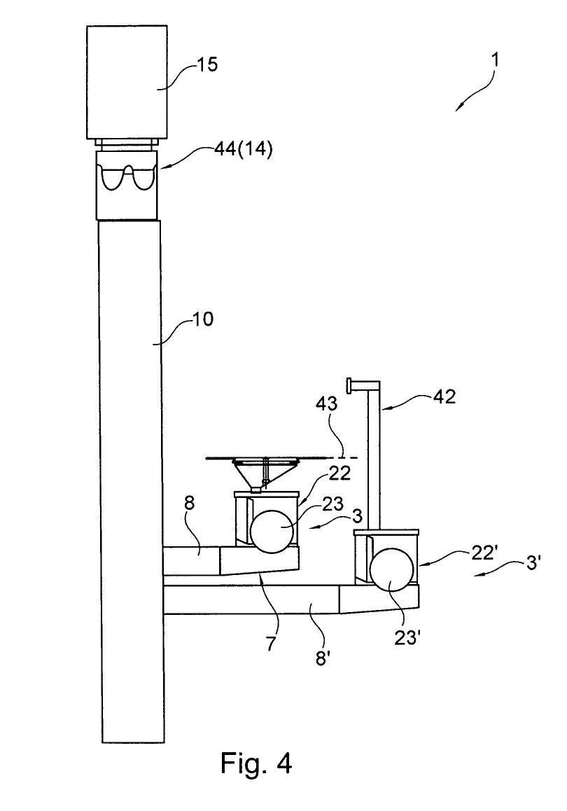

In another exemplary embodiment, FIG. 4 shows the arrangement of two sealing devices 3, 3′, wherein the first sealing device 3 is situated on a discharge device 7 and the second sealing device 3′ on an overflow device 42 of the vacuum urinal (not shown here). The level of the overflow outlet (not shown here) is known to lie over the outlet level 43 used in regular flushing processes.

In a flushing process, the primary air stream is guided through the bypass line 10, which is coupled via a suction valve (not shown here) to a vacuum system (also not shown here). The spherical closures 23, 23′ in the containers 22, 22′ are respectively drawn toward the gasket 40 shown on FIG. 3 under the vacuum generated by the vacuum system during the flushing process, forming a tight seal. As a consequence, no air is aspirated during the flushing process at the discharge 6 and at the overflow device 42. Therefore, no flow-related noises come about at the discharge 6 and overflow device 42. After the flushing process, the weight of the spherical closures 23, 23′ causes them to seal off the lower opening cross sections 25, 25′ relative to the discharge line 8 or discharge line 8′, and the odors from the discharge lines 8 and bypass line 10 cannot escape the discharge 6 or overflow device 42.

The mesh width of the depicted screen 34 depends on the construction of the sealing devices 3, 3′. The screen 34 is intended to prevent the sealing devices 3, 3′ from becoming jammed.

In addition to the arrangement of the two sealing device 3, 3′, FIG. 4 shows especially clearly a butterfly check valve 44 situated at the upper end of the bypass line 10 as the valve seal 14, and an aspirating sound damper 15 above the butterfly check valve 44, which minimizes background noises that arise during the flushing process. The butterfly check valve 44 is only provided for operation with air. The sealing devices 3, 3′ are arranged parallel to the bypass line 10, and designed especially for fluids. The incline and the pipe diameter of the discharge line 8 along with all remaining lines should primarily enable a complete evacuation of discharging fluids and transported material. Waterless operation of the depicted urinal system 1 is also possible. Let it further be noted that the flaps of the butterfly check valve 44 are provided all around with a seal in the form of a gasket ring to increase tightness and prevent rising odors from escaping.

In order to execute a flushing process as described once again based on FIG. 1, the control unit 20 that sets the valve operating times is activated via a trigger device 21 after usage of the urinal bowl 5.

In a preferred embodiment, a valve siphon 6 first opens for roughly one second, thereby introducing flushing water into the urinal bowl 5, and causing other contaminants present in the urinal bowl 5 to be transported into the discharge line 8 via the screen 34 and the sealing device 3. Before the control unit 20 opens the suction valve 17, the transported material (urine, contaminants and the flushing water) flows into the discharge line 8, assisted by gravity, and via a mandatory inclination of the discharge line 8 over the coupling 11 into the bypass line 10 up to the suction valve 17. The valve siphon 6 is then closed, and the suction valve 17 is preferably opened for roughly 2 to 3 seconds, as a result of which the substances accumulated in the area of the urinal bowl 5, discharge line 8 and bypass line 10 are removed by a pressure differential created by the vacuum system 19 and pass into the wastewater line and further into the vacuum system. The noise made by the supply of air to the suction valve 17 is attenuated by the sound damper 15, thereby suppressing disturbing noise emissions.

As mentioned before, the invention can be further developed in such a way as to also operate the system as a “waterless urinal”. The urinal bowl geometry should here preferably exhibit a geometry that supports a gravity-assisted discharge of fluids to the urinal bowl surface. An anti-adhesive surface coating should also be used in the urinal bowl to facilitate the discharge. Further, all surfaces within the container 22 that can be wetted by fluid or transported material, but in particular the spherical closure 23, should exhibit an anti-adhesive surface coating or anti-adhesive surface.

Even though the invention was described above drawing reference to preferred exemplary embodiments, various changes and modifications can be introduced without going beyond the protective scope of the invention. The invention can basically be used in all areas of aviation. In like manner, the invention can be used in trains or ships, which also utilize vacuum toilets. The invention can basically always be used in cases where the problem involves the reduction of noise emissions and/or odors. Finally, other operating times can also be set for the suction valve and the valve siphon as a function of how the vacuum toilet is dimensioned.

In addition, it must be noted that “having”, “exhibiting”, and “containing” does not preclude other elements or steps, and that “an” or “one” does not rule out a plurality. Let it be further noted that features or steps described with reference to one of the above exemplary embodiments can also be used in combination with other features or steps in other exemplary embodiments described above. Reference numbers in the claims are not to be construed as a limitation.

1. A sealing device for vacuum urinals in aircraft, comprising:
a container with an upper opening cross section and a lower opening cross section;
a spherical closure in the form of a sphere;
wherein the diameter of the spherical closure is greater than the diameter of the lower opening cross section;
wherein the spherical closure can be accommodated by the container, and moved from a sealed setting to an open setting and from the open setting to the sealed setting;
wherein the lower opening cross section is sealed by the spherical closure in the sealed setting; and
wherein the upper opening cross section is circular, and the midpoint of the opening cross section is arranged at a lateral distance to an uppermost point of the spherical closure.

2. The sealing device of claim 1, wherein the spherical closure and/or the container have an anti-adhesive surface.

3. The sealing device of claim 1, further comprising a guiding means through which the spherical closure is movably guided.

4. A vacuum urinal in aircraft, comprising:
a first and second sealing device, each sealing device comprising:
a container with an upper opening cross section and a lower opening cross section;
a spherical closure in the form of a sphere;
wherein the diameter of the spherical closure is greater than the diameter of the lower opening cross section;
wherein the spherical closure can be accommodated by the container, and moved from a sealed setting to an open setting and from the open setting to the sealed setting;
wherein the lower opening cross section is sealed by the spherical closure in the sealed setting;
wherein the upper opening cross section is circular, and the midpoint of the opening cross section is arranged at a lateral distance to an uppermost point of the spherical closure; and
wherein the first sealing device is located on a discharge device of the vacuum urinal, and the second sealing device is located on an overflow device of the vacuum urinal.

5. A vacuum urinal in aircraft, having a sealing device of claim 1, wherein the vacuum urinal is waterless.

6. A method for actuating a sealing device comprising,
a container with an upper opening cross section and a lower opening cross section;
a spherical closure in the form of a sphere;
wherein the diameter of the spherical closure is greater than the diameter of the lower opening cross section;
wherein the spherical closure can be accommodated by the container, and moved from a sealed setting to an open setting and from the open setting to the sealed setting;
wherein the lower opening cross section is sealed by the spherical closure in the sealed setting;
wherein the upper opening cross section is circular, and the midpoint of the opening cross section is arranged at a lateral distance to an uppermost point of the spherical closure;
wherein the spherical closure is moved from the sealed setting to the open setting by imparting buoyancy to the spherical closure during the introduction of liquid, releasing the lower opening cross section;
wherein the spherical closure is moved from the open setting to the sealed setting when the spherical closure seals the lower opening cross section under its own weight as the liquid is discharged; and
wherein the liquid is introduced through one of the opening cross sections into the container in such a way that a tangent applied to the direction of liquid flow intersects the spherical closure spaced apart from the midpoint of the spherical closure.

7. The method of claim 6, wherein the spherical closure is moved from the open setting to the sealed setting by generating a vacuum in the area of the lower opening cross section.

8. An airplane having at least one sealing device, the sealing device comprising:
a spherical closure in the form of a sphere;
wherein the diameter of the spherical closure is greater than the diameter of the lower opening cross section;
wherein the spherical closure can be accommodated by the container, and moved from a sealed setting to an open setting and from the open setting to the sealed setting;
wherein the lower opening cross section is sealed by the spherical closure in the sealed setting; and
wherein the upper opening cross section is circular, and the midpoint of the opening cross section is arranged at a lateral distance to an uppermost point of the spherical closure.
